(19) United States
(12) Patent Application Publication
(10) Pub. No.: US 2007/0119380 A1
(43) Pub. Date: May 31, 2007

(54) Additive Composition for Feeding Aquaculture Animals and Feed Containing the Same

(76) Inventors: Hau Yin Chung, Shatin (CN); Put O. Ang JR., Shatin (CN); Ying Shin Norman Woo, Sheung Shui (CN); Wing Chi Joyce Ma, Shatin (CN)

Correspondence Address: McAndrews, Held & Malloy, Ltd., 34th Floor, 500 W. Madison Street, Chicago, IL, 60661, US

(21) Appl. No.: 11/669,741

(22) Filed: Jan. 31, 2007

Related U.S. Application Data
(63) Continuation of application No. 10/890,695, filed on Jul. 14, 2004.
(60) Provisional application No. 60/486,944, filed on Jul. 14, 2003.

(51) Int. Cl. A01K 61/00

(52) U.S. Cl. 119/230

(57) ABSTRACT

Disclosed is an additive composition of a feed for breeding an organism comprising at least one genus of marine algae containing an effective amount of one or more compounds selected from the group consisting of unsubstituted bromophenols and bromophenols substituted with one or more substituents. Also disclosed are a feed containing the additive composition and a method for preparing the feed. Applications of the feed disclosed herein to aquaculture animals can greatly enhance the organoleptic quality of such aquaculture animals.

### RELATED APPLICATIONS

This application is a continuation of prior application Ser. No. 10/890,695, filed on Jul. 14, 2004, which claims the benefit of U.S. provisional application No. 60/486,944, filed on Jul. 14, 2003. Both the prior application Ser. No. 10/890,695 and the provisional application No. 60/486,944 are hereby incorporated by reference in their entirety.

### FIELD OF THE INVENTION

The present invention relates generally to an additive composition for feeding an organism and a feed containing the same, particularly to an additive composition derived from marine algae that may enhance the organoleptic quality in aquaculture animal. The present invention also relates generally to a method for enhancing the organoleptic quality of an aquaculture animal by feeding the animal with the feed of the present invention.

### BACKGROUND OF THE INVENTION

U.S. Pat. No. 6,391,331 is concerned with the application of seaweed supplement to cattle and swine to enhance quality other than flavor one. But, it doesn't deal with marine animals.

U.S. Pat. No. 5,350,588 discloses a feed that requires an extraction step operated at warm temperature. The dried and grinded product is mixed at suitable proportion to the original feed, and subjected to drying process. The requirement of at least one type of bromophenols is necessary for the enhancement of the flavor in the current invention.

The flavor of seafood, composed of both volatile and nonvolatile components, is closely related to the perception of the consumers. See Lindsay, R. C., Food Rev. Int., 1990, 6, 437-455; Josephson, D. B., Seafood, In Volatile Compounds in Foods and Beverages; Maarse, H. Ed.; Marcel Dekker: New York, N.Y., 1991, pp 179-202; Shahidi, F.; Cadwallader, K. R. Flavor and lipid chemistry of seafoods: an overview. In Flavor and Lipid Chemistry of Seafoods; ACS Symposium Serious 674; Shahidi, F.; Cadwallader, K. R. Eds.; American Chemical Society: Washington, D.C., 1997; pp 1-8. The nonvolatile taste-active constituents include nucleotides and free amino acids, and the volatile compounds include lipid-derived compounds such as alcohols, aldehydes, ketones, sulfur- and nitrogen-containing compounds, etc. See Josephson, D. B., Seafood, In Volatile Compounds in Foods and Beverages; Maarse, H. Ed.; Marcel Dekker: New York, N.Y., 1991; pp 179-202. Chung, H. Y. J. Agric. Food Chem. 1999, 47, 2280-2287; Chung, H. Y.; Yung, I. K. S.; Ma, W. C. J.; Kim, J. S. Food Res. Int. 2002, 35, 43-53.

Compounds that are responsible for the sea- or brine-like aroma are related to a group of bromophenol homologues including 2-bromophenol, 4-bromophenol, 2,4-dibromophenol, 2,6-dibromophenol and 2,4,6-tribromophenol. See Boyle, J. L.; Lindsay, R. C.; Stuiber, D. A. J. Food Sci. 1992a, 57, 918-922; Boyle, J. L.; Lindsay, R. C.; Stuiber, D. A. J. Aquat. Food Prod. Technol. 1992b, 1, 43-63; Whitfield, F. B.; Helidoniotis, F.; Shaw, K. J.; Svoronos, D. J. Agric. Food Chem. 1998, 46, 3750-3757. One or more of these bromophenols are commonly detected in different species of seafood, including marine fish, crustaceans, mollusks, etc. in different locations around the world, but are absent in the fresh water animals. See Boyle, J. L.; Lindsay, R. C.; Stuiber, D. A. J. Food Sci. 1992a, 57, 918-922; Whitfield, F. B.; Helidoniotis, F.; Shaw, K. J.; Svoronos, D. J. Agric. Food Chem. 1997, 45, 4398-4405; Whitfield, F. B.; Helidoniotis, F.; Shaw, K. J.; Svoronos, D. J. Agric. Food Chem. 1998, 46, 3750-3757; Ma, W. C. J. Evaluation of bromophenols in Hong Kong seafood and enhancement of bromophenol contents in an aquacultured fish (Sparus sarba) (Thesis), The Chinese University of Hong Kong, HKSAR, China, 2002. They are produced by marine algae and polychaetes, and distributed throughout the food chain. See Boyle, J. L.; Lindsay, R. C.; Stuiber, D. A. J. Food Sci. 1992a, 57, 918-922; Boyle, J. L.; Lindsay, R. C.; Stuiber, D. A. J. Aquat. Food Prod. Technol. 1992b, 1, 43-63; Whitfield, F. B.; Shaw, K. J.; Walker, D. I. Water Sci. Technol. 1992, 25, 131-139.

Wild marine animals obtain their bromophenols from their diets and accumulate at each level along the food chain. The differences between the bromophenol contents in the wild-harvested and the aquacultured seafood are due to the differences in their diet contents. Several methods would be possible to increase the bromophenol content in the latter. Among them, direct addition of bromophenol chemicals to the cultivation water was found to be impractical and not environmentally friendly. Alternatively, incorporation of pure chemical bromophenols to the animal feeds had failed as majority of the chemicals were lost in the feed production process. A method to incorporate the animal feed with natural sources of bromophenols is a more practical choice because bromophenols appear to be more securely bound to their original cell structure. See Whitfield, F. B.; Helidoniotis, F.; Shaw, K. J.; Svoronos, D. J. Agric. Food Chem. 1997, 45, 4398-4405. Marine algae containing specific enzyme system are capable of producing bromophenols high in concentration which is affected by the seasons. See Whitfield, F. B.; Helidoniotis, F.; Shaw, K. J.; Svoronos, D. J. Agric. Food Chem. 1999, 47, 2367-2373; Ma, W. C. J. Evaluation of bromophenols in Hong Kong seafood and enhancement of bromophenol contents in an aquacultured fish (Sparus sarba) (Thesis), The Chinese University of Hong Kong, HKSAR, China, 2002. In fact, the marine algae can be an ideal choice as a natural dietary supplement of bromophenols and other dietary sources of protein and lipid for aquacultured animals. Wahbeh, M. I. Aquaculture 1997, 159, 101-109.

### BRIEF SUMMARY OF THE INVENTION

Accordingly, an object of the invention is to provide an additive composition of a feed for breeding an organism, which comprises at least one genus of marine algae containing an effective amount of one or more compounds selected from the group consisting of unsubstituted bromophenol and bromophenols substituted with one or more substituents. The substituent can be a halo (e.g., bromo), hydroxyl, lower alkyl, lower alkoxyl, or carboxyl group.

Another object of the invention is to provide a feed for an organism, which comprises an effective amount of an additive composition including at least one genus of marine algae containing one or more compounds selected from the group consisting of unsubstituted bromophenol and bromophenols substituted with one or more substituents, and a conventional feed.

A further object of the invention relates to a method for preparing the feed described herein, which comprises the steps of:

a) drying at least one genus of marine algae; and

b) mixing an amount of dried marine algae with a conventional feed.

Still another object of the invention is directed to a method for enhancing the organoleptic quality of an aquaculture animal comprising the step of feeding the aquaculture animal a feed that comprises: an effective amount of at least one genus of marine algae containing at least one bromophenol, a derivative thereof, or a mixture thereof; and a conventional feed.

The invention enhances the flavor quality of the carcass of aquacultured animals. The technology of the invention can be widely used in the aquaculture industry to improve their product quality and hence increase their market value.

### BRIEF DESCRIPTION OF SEVERAL VIEWS OF THE DRAWINGS

FIG. 1 shows mean total bromophenol contents in the flesh of silver seabream with different fish feeds in accordance with Example 1 of the present invention.

### DETAILED DESCRIPTION OF THE INVENTION

The active composition of a feed according to the present invention incorporates the dried marine algae containing 2-bromophenol and/or a 2-bromophenol derivative; 4-bromophenol and/or a 4-bromophenol derivative; 2,4-dibromophenol and/or a 2,4-dibromophenol derivative; 2,6-dibromophenol and/or a 2,6-dibromophenol derivative; 2,4,6-tribromphenol and/or a 2,4,6-tribromophenol derivative, or a combination thereof, as an active ingredient. The feed of the present invention is very useful for improving the organoleptic property of an aquaculture animal. For example, such a feed is effective in enhancing the flavor quality of the aquaculture animal.

The marine algae can be from any of the various algal classifications, preferably those that have been utilized in agriculture. Genus groups referred to in the invention include red algae such as Amphiroa, Callophycus, Cheilosporum, Chondria, Corallina, Delisea, Galaxaura, Gracilaria, Haliptilon, Halymenia, Lomentaria, Plocamium, Porphyra, Pterocladiella, Solieri; brown algae such as Cladostephus, Colpomenia, Cystophora, Ecklonia, Endarachne, Halopteris, Homoestrichus, Hormosira, Lobophora, Padina, Phyllospora, Sargassum, Sporochnus; green algae such as Caulerpa, Chlorodesmis, Cladophoropsis, Codium, Enteromorpha, Halimeda and Ulva. (Chung, H. Y.; Ma, W. C. J.; Put, O. A. Jr.; Kim, J.-S.; Chen, F. J. Agric. Food Chem. 2003, 51, 2619-2624; Whitfield, F. B.; Helidoniotis, F.; Shaw, K. J.; Svoronos, D. J. Agric. Food Chem. 1999, 47, 2367-2373.). In accordance with one embodiment of the present invention, the marine alga is preferably from the genus of Sargassum, and more preferably from Sargassum siliquastrum.

Dried marine algae which can be used in the invention can be obtained by dehydrating marine algae used, for example, by freeze-drying and grinding the dehydrated material into a powder. The algal powder can then be mixed with a conventional dry feed in powder to form a feed of the invention in a desirable proportion. In one embodiment, a feed powder containing about 30% by weight of the algal powder based on the total amount of the feed and water can be provided to form a soft dough for shaping into a suitable form using a suitable equipment, such as an extruder. The feed of the present invention can then be obtained by dehydrating the wet feed, for example, by freeze-drying.

Flavor quality of the marine animals can be evaluated using the Triangle test of the discrimination test, for example. According to this test, subjects are trained before actual products evaluation on the control and the experimental samples. Subjects are asked to pick out one sample which is different from the other two samples. Settings of the evaluation facility can be set according to Meilgaard, M.; Civille, G. V.; Carr, B. T. Sensory Evaluation Techniques, 2nd ed,; CRC Press, Inc.: Boca Baton, 1991. Replicated tests are carried out by each subject. Results are statistically evaluated at p=0.05 level of significance based on the published table in Roessler, E. B.; Pangborn, R. M.; Sidel, J. L.; Stone, H. Food Sci. 1978, 43, 940-947.

The bromophenol compounds produced from marine algae are as metabolites in them. The feed of the present invention includes 2-bromophenol and/or 4-bromophenol and/or 2,4-dibromophenol and/or 2,6-dibromophenol and/or 2,4,6-tribromophenol and/or their derivatives. Such a feed is very effective to enhance the flavor quality of the marine animals.

Because the concentration of each bromophenol in the marine algae may vary at the time of collection, all marine algae collected, dried and ground are preferably mixed first before being incorporated into a conventional dry feed.

In one embodiment of the present invention, the feed includes a 30% Sargassum silliquastrum feed additive, with average concentrations of 2-bromphenol, 4-bromophenol, 2,4-dibromophenol, 2,6-dibromophenol and 2,4,6-tribromophenol at 3.87, 3.49, 67.2, 6.88 and 157 ng/g dry weight, respectively.

Conventional dry feeds include those produced using raw materials derived from animals such as fish meal, casein and squid meal; plant such as dextrin, soybean cake, wheat flour, starch and feed yeast; animal oil such as lard, cod-liver oil, squid-liver oil; and plant oil such as soybean oil and rape-seed oil, which may further include vitamins, minerals, amino acids antioxidants, and binder and the like. An example of the conventional dry feeds is composed of white fishmeal, dextrin, vegetable oil, lard, vitamin mix, mineral mix and carboxymethyl cellulose in the weight percentage of 82.66, 1.54, 6, 2.5, 2, 3.8 and 1.5, respectively. (See Woo, N. Y. S; Kelly, S. P. Aquaculture 1995, 135, 229-238.)

The active composition of a feed of the present invention for breeding an organism containing at least one species of marine algae which contains at least one compound selected from the group consisting of 2-bromophenol and/or 4-bromophenol and/or 2,4-dibromophenol and/or 2,6-dibromophenol and/or 2,4,6-tribromophenol and/or a derivative thereof and the feed of the present invention containing the active composition as an active ingredient may be produced according to methods known in this field.

The content of the active composition of the present invention in the feed for the organism of interest is not limited to a specific one and may be determined depending on the animal to be fed.

The method of preparing the feed of the present invention can be performed using conventional technique in this field. One embodiment of the invention includes adding at least one dried marine alga which contains at least one bromophenol, a derivative thereof, or a combination thereof to a conventional feed.

The dry feed of the present invention can be directly fed to the marine animals during the finishing period which preferably is at least 30 days before transportation to slaughter.

The minimal amounts (equivalent to the flavor threshold value) of each bromophenol in the whitefish flesh/muscle to produce a recognizable sensation, are 10, 20, 50, 0.1 and 10 ng/g in fresh/wet sample for 2-bromphenol, 4-bromophenol, 2,4-dibromophenol, 2,6-dibromophenol and 2,4,6-tribromophenol, respectively (Boyle, J. L.; Lindsay, R. C.; Stuiber, D. A. J. Food Sci. 1992a, 57, 918-922; Boyle, J. L.; Lindsay, R. C.; Stuiber, D. A. J. Aquat. Food Prod. Technol., 1992b, 1, 43-63). Other marine animals will have similar flavor enhancement when the concentration of one or more bromophenols are equal to or above the minimal flavor threshold value.

Organisms to which the present invention can be applied include, but not limited to, cultured animals such as fishes (e.g. parrot fishes, flatfishes, yellowtails, young yellowtails, yellow jacks, salmon, trouts), crustaceans (e.g. glass shrimp, black tiger shrimps, blue crabs, red crabs) and shellfishes (e.g. scallops and oysters). The present invention can be widely applied to aquatic animals.

Interperitoneal and oral administrations of 2-bromophenol, 2,4-debromophenol and 2,4,6-tribromophenol produce no sub-lethal toxic effects in mice (Sweet, D. V. Registry of Toxic Effects of Chemical Substances, Vol. 4; U.S. Government Printing Office: Washington, D.C., 1987.). Comparing the LD₅₀ value of 2,4,6-tribromophenol administrated orally in rat and the concentration value in seafood on the same basis, the lethal dose is 200 to 500 times higher than the highest concentrations detected in the Australian crustaceans (Whitfield, F. B.; Last, J. H.; Shaw, K. J.; Tindale, C. R. J. Sci. Food Agric. 1988, 24, 29-42; Boyle, J. L.; Lindsay, R. C.; Stuiber, D. A. J. Aquat. Food Prod. Technol., 1993, 2, 75-112). With small amount of bromophenols found in seafood, the harmful effect is not critical to health.

Flavor quality in an organism of interest such as a laboratory animal, a fish, a crustacean, a shellfish can be enhanced with the product of the invention. Such enhancement can be accomplished by feeding the organism a feed containing at least one type of marine alga containing 2-bromophenol and/or 4-bromophenol and/or 2,4-bromophenol and/or 2,6-dibromophenol and/or 2,4,6-tribromophenol and/or their derivatives.

Cultured animals have the problem of culturing with a feed that contains low quantity of alga which contains the bromophenols and/or their derivatives. The new bromophenol- and/or derivative-containing algae dry feed of the present invention can greatly improve the flavor quality in the cultured animals bred in an aquaculture farm.

The present invention provides a feed for an aquatic animal composing of at least one type of marine alga which contains 2-bromophenol and/or 4-bromophenol and/or 2,4-bromophenol and/or 2,6-dibromophenol and/or 2,4,6-tribromophenol and/or derivatives thereof and a conventional dry feed. The feed is very useful as a flavor-enhancing feed.

The present invention provides a method for breeding an aquatic animal, characterized in that the method comprises feeding the animal at least one type of marine alga which contains 2-bromophenol and/or 4-bromophenol and/or 2,4-bromophenol and/or 2,6-dibromophenol and/or 2,4,6-tribromophenol and/or derivatives thereof and a conventional feed.

### EXAMPLE 1

A traditional feed was prepared from white fishmeal, dextrin, vegetable oil, lard, vitamin mix, mineral mix, carboxymethyl cellulose with weight percentage of 82.66, 1.54, 6, 2.5, 2, 3.8 and 1.5, respectively, with a method by Woo, N. Y. S; Kelly, S. P. Aquaculture 1995, 135, 229-238. The prepared dough was extruded using an extruder to produce wet pellets which were freeze-dried and stored at refrigeration temperature of 4° C.

A modified feed of the invention was prepared by the incorporation of 30% (w/w) freeze-dried algae in powder form, Sargassum siliquastrum, into the traditional feed. Acclimatized silver seabreams (100 g each) cultivated in indoor 1-tonne tanks with a closed seawater circulating system were divided into two groups for comparison for their bromophenols contents every two weeks after they were fed with tradition and modified feeds. Fishes were fed daily and the amount was 2-3% of the body weight of fish.

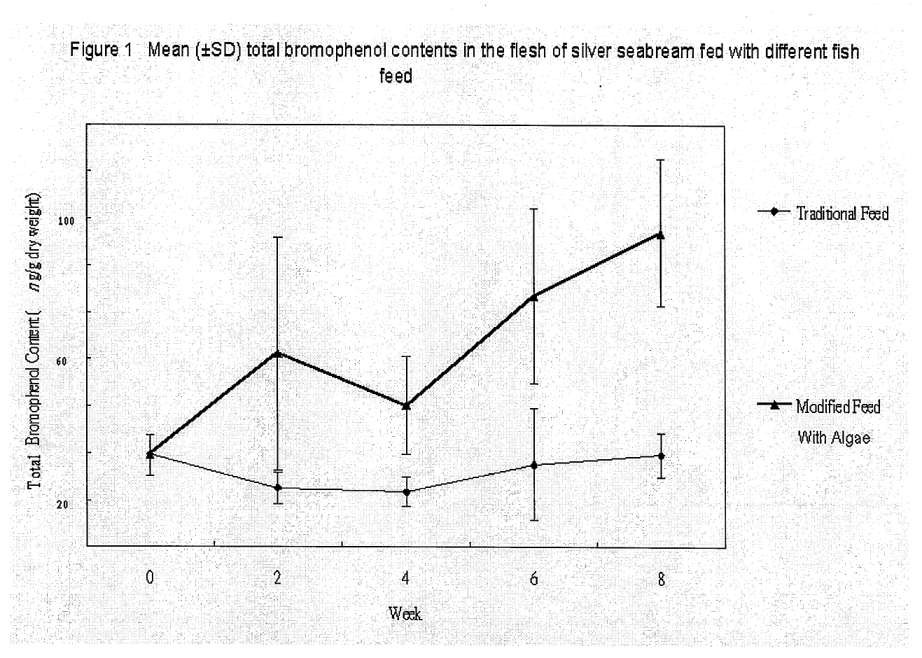

Total bromophenol contents are the sum of the concentration of all five bromophenols determined by the internal standard method using a continuous steam distillation and solvent extraction technique as described elsewhere (Chung, H. Y.; Ma, W. C. J.; Kim, J.-S., J Agric. Food Chem. 2003, 51, 6752-6760; Chung, H. Y.; Ma, W. C. J.; Ang, P. O. Jr.; Kim, J.-S.; Chen, F., J. Agric. Food Chem. 2003, 51, 2619-2624; Whitfield, F. B.; Helidoniotis, F.; Shaw, K. J.; Svoronos, D. J. Agric. Food Chem. 1997, 45, 4398-4405; Whitfield, F. B.; Helidoniotis, F.; Shaw, K. J.; Svoronos, D. J. Agric. Food Chem. 1999, 47, 2367-2373). The result was showed in FIG. 1.

Data in FIG. 1 showed that the bromophenol content in the fish could be significantly (p<0.05) increased with the use of 30% (wt/wt) marine algae in the feed. Sensory evaluation of the cooked products showed that the fish fed with the special feed of the present invention were significantly (p<0.05) different from that fed with the original conventional dry feed containing no marine algae.

What is claimed is:

1. A method for enhancing the organoleptic quality of an aquaculture animal comprising the step of feeding the aquaculture animal a feed that comprises: an effective amount of at least one genus of marine algae containing at least one bromophenol, a derivative thereof, or a mixture thereof; and a conventional feed.

2. The method of claim 1, wherein the aquaculture animal is a domestic animal, a laboratory animal, a fish, a crustacean or a shellfish.

3. The method of claim 1, wherein the derivative of the at least one bromophenol is a bromophenol substituted with one or more substituents.

4. The method claim 3, wherein the one or more substituents are halo, hydroxyl, lower alkyl, lower alkoxyl, carboxyl, or a combination thereof.

5. The method of claim 4, wherein said halo is bromo.

6. The method of claim 1, wherein said at least one bromophenol is selected from the group consisting of 2-bromophenol, 4-bromophenol, 2,4-dibromophenol, 2,6-dibromophenol, 2,4,6-tribromophenol, and combinations thereof

7. The method of claim 1, wherein said marine algae are red algae, brown algae, green algae, or a combination thereof.

8. The method of claim 1, wherein said at least one genus of marine algae is selected from the group consisting of Amphiroa, Callophycus, Cheilosporum, Chondria, Corallina, Delisea, Galaxaura, Gracilaria, Haliptilon, Halymenia, Lomentaria, Plocamium, Porphyra, Pterocladiella, Solieri, Cladostephus, Colpomenia, Cystophora, Ecklonia, Endarachne, Halopteris, Homoestrichus, Hormosira, Lobophora, Padina, Phyllospora, Sargassum, Sporochnus, Caulerpa, Chlorodesmis, Cladophoropsis, Codium, Enteromorpha, Halimeda, Ulva, and combinations thereof.

9. The method of claim 1, wherein said at least one genus of marine algae comprises Sargassum.

10. The method of claim 1, wherein said at least one genus of marine algae comprises Sargassum siliquastrum.

11. The method of claim 1, wherein the feed comprises at least about 30% by weight of the at least one genus of marine algae, based on the total weight of the feed.

12. The method of claim 1, wherein the feed comprises about 30% by weight of Sargassum siliquastrum, based on the total weight of the feed.

13. The method of claim 1, wherein the at least one genus of marine algae contains 2-bromophenol or a derivative thereof, 4-bromophenol or a derivative thereof, 2,4-dibromophenol or a derivative thereof, 2,6-dibromophenol or a derivative thereof, and 2,4,6-tribromophenol or a derivative thereof.

14. A method for enhancing the organoleptic quality of an aquaculture animal comprising the step of feeding the aquaculture animal a feed for at least 30 days immediately prior to the slaughter of the aquaculture animal, wherein said feed comprises: an effective amount of at least one genus of marine algae containing at least one bromophenol, a derivative thereof, or a mixture thereof; and a conventional feed, during the finishing period of the aquaculture animal.

15. The method of claim 14, wherein the derivative of the at least one bromophenol is a bromophenol substituted with one or more substituents.

16. The method claim 15, wherein the one or more substituents are halo, hydroxyl, lower alkyl, lower alkoxyl, carboxyl, or a combination thereof.

17. The method of claim 16, wherein said halo is bromo.

18. The method of claim 14, wherein said at least one bromophenol is selected from the group consisting of 2-bromophenol, 4-bromophenol, 2,4-dibromophenol, 2,6-dibromophenol, 2,4,6-tribromophenol, and combinations thereof.

19. The method of claim 14, wherein the at least one genus of marine algae contains 2-bromophenol or a derivative thereof, 4-bromophenol or a derivative thereof, 2,4-dibromophenol or a derivative thereof, 2,6-dibromophenol or a derivative thereof, and 2,4,6-tribromophenol or a derivative thereof.

20. The method of claim 14, wherein the feed comprises at least about 30% by weight of the at least one genus of marine algae, based on the total weight of the feed.
